(19) United States
(12) Patent Application Publication
(10) Pub. No.: US 2026/0054365 A1
(43) Pub. Date: Feb. 26, 2026

(54) WORKING MACHINE

(71) Applicant: Koki Holdings Co., Ltd., Tokyo (JP)

(72) Inventors: Mikihiro KATAOKA, Ibaraki (JP); Naoto ICHIHASHI, Ibaraki (JP)

(21) Appl. No.: 19/104,802

(22) PCT Filed: Aug. 10, 2023
(86) PCT No.: PCT/JP2023/029231

§ 371 Date: Feb. 19, 2025

(30) Foreign Application Priority Data
Aug. 19, 2022 (JP) 2022-130926

(51) Int. Cl. B25F 5/00; A01D 34/76; A01D 101/00

(52) U.S. Cl. CPC B25F 5/008; A01D 34/76; A01D 2101/00

(57) ABSTRACT

Workability of a working machine is enhanced. A bush cutter includes a motor, a control unit, a fan, a housing, and a front cover. A microcomputer for controlling driving of the motor is mounted on the control unit. The fan generates airflow when receiving a driving force of the motor. The housing houses the motor, the control unit, and the fan, and includes an opening. The control unit has a plate shape with an outer shape size maximized when being viewed in a front-back direction, and is arranged between the opening and the fan in the front-back direction. The front cover is erected from an inner wall of the housing to overlap the control unit when being viewed in the front-back direction.

### TECHNICAL FIELD

The present invention relates to a working machine driven by driving of a motor.

### BACKGROUND ART

In a working machine described in a Patent Document 1, a control substrate for controlling rotation of an electric motor is included in a motor housing. A heat sink is attached to the control substrate.

### RELATED ART DOCUMENT

### Patent Document

Patent Document 1: Japanese Patent Application Laid-open Publication No. 2022-84079

### SUMMARY OF THE INVENTION

### Problems to be Solved by the Invention

As described in the Patent Document 1, in the working machine in which a controller provided with a control portion controls the driving of the motor, if workload on the working machine increases, the working machine controls an electric current to flow more. Thus, a heat amount generated in the control portion is possibly larger than a heat amount generated before the increase in the workload. At this time, if the electric current to be used is controlled so as not to exceed an upper limit value, there is a possibility of decrease in workability of the working machine due to stop of an operation of the working machine or the like.

An objective of the present invention is to provide a working machine with enhanced workability.

### Means for Solving the Problems

A working machine according to one embodiment includes: a motor; a controller provided with a control portion configured to control driving of the motor; a fan configured to generate airflow when receiving a driving force of the motor; and a housing configured to house the motor, the controller, and the fan and to include an opening. The controller has a plate shape with an outer shape size maximized when being viewed in a first direction, and is arranged between the opening and the fan in the first direction, and a wall erected from an inner wall of the housing is provided to overlap the controller when being viewed in the first direction.

### Effects of the Invention

According to the present invention, the workability of the working machine can be enhanced.

### BRIEF DESCRIPTIONS OF THE DRAWINGS

FIG. 1 is a right side view illustrating a bush cutter as an exemplary working machine.

FIG. 2 is a perspective view of a driving unit from which a battery unit is detached.

FIG. 3 is a perspective view of the driving unit from which a left housing is removed.

FIG. 4 is a cross-sectional view (that is a cross-sectional view taken along a line 4-4 of FIG. 9) illustrating an internal structure of the driving unit.

FIG. 5 is a perspective view of a control unit viewed from diagonal front.

FIG. 6 is a back side view of the control unit viewed from back.

FIG. 7 is a plan view of the control unit viewed from above.

FIG. 8 is a left side view of the control unit viewed from left.

FIG. 9 is a left side view of the driving unit from which the left housing is detached, viewed from left.

FIG. 10 is a perspective view of the driving unit from which the left housing is detached, viewed from diagonal front.

FIG. 11 is a perspective view of a right housing.

FIG. 12 is a right side view of the driving unit from which the right housing is detached, viewed from right.

FIG. 13 is a perspective view of the driving unit from which the right housing is detached, viewed from diagonal front.

FIG. 14 is a perspective view of the left housing.

FIG. 15 is a cross-sectional view (that is a cross-sectional view taken along a line 15-15 of FIG. 9) illustrating a layout state of the control unit in the housing.

FIG. 16 is a cross-sectional view (that is a cross-sectional view taken along a line 16-16 of FIG. 9) illustrating a layout state of the control unit in the housing.

FIG. 17 is an explanatory diagram illustrating a state of airflow around the control unit.

FIG. 18 is a left side view illustrating a hammer drill as an exemplary working machine.

FIG. 19 is a cross-sectional view (that is a cross-sectional view taken along a line 211-211 of FIG. 18) illustrating an inner structure of the hammer drill.

### DETAILED DESCRIPTION OF PREFERRED EMBODIMENTS

An embodiment of the present invention will be explained below with reference to the drawings. Note that each drawing will be explained while a direction with a front-back arrow indicates a front-back direction, a direction with a right-left arrow indicates a right-left direction, and a direction with an upper-lower arrow indicates an up-down direction.

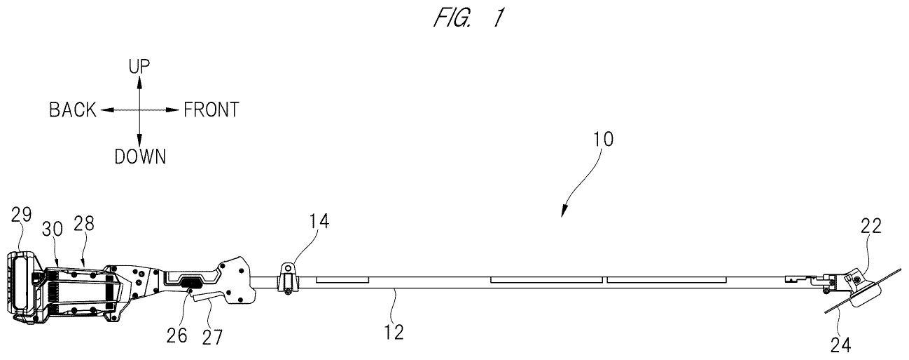

FIG. 1 illustrates a bush cutter 10 as an exemplary working machine. The bush cutter 10 is used to cut, for example, grasses or small-diameter trees. The bush cutter 10 includes a main pipe 12, a handle attachment 14, a gear box 22, a rotary blade 24, a grip 26, and a driving unit 28.

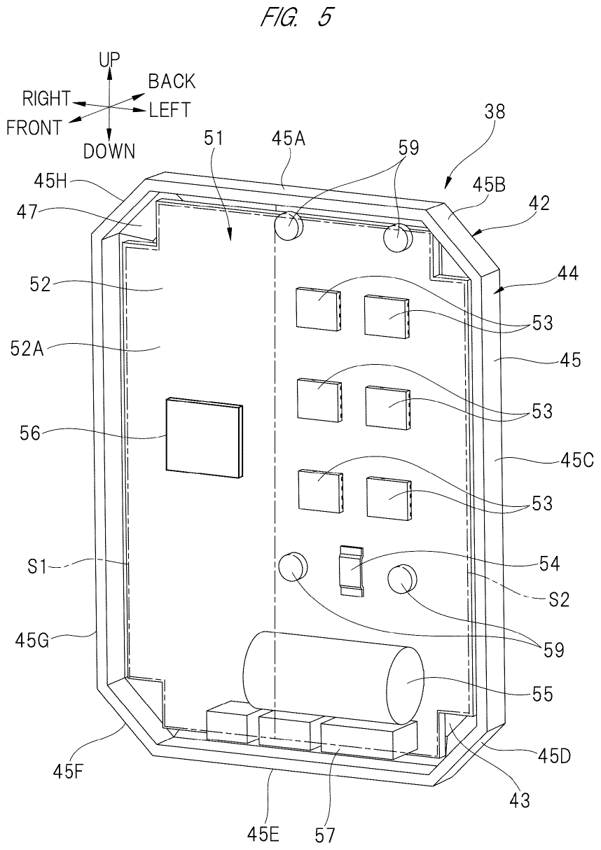

The main pipe 12 is a cylindrical member extending in one direction. A drive shaft not illustrated is inserted into the main pipe 12. A handle to be gripped by a worker but not illustrated can be attached to the handle attachment 14. The grip 26 is provided with a lever 27 to be operated by the worker. When an operation amount of the lever 27 operated by the worker changes, a microcomputer 56 (FIG. 5) described later operates and controls, thereby changing a rotation speed of the rotary blade 24. The gear box 22 is provided at one end of the main pipe 12. The rotary blade 24 is attached to the gear box 22. The gear box 22 transmits a driving force caused in a driving unit 28 described later to the rotary blade 24. The driving unit 28 is provided at the other end of the main pipe 12.

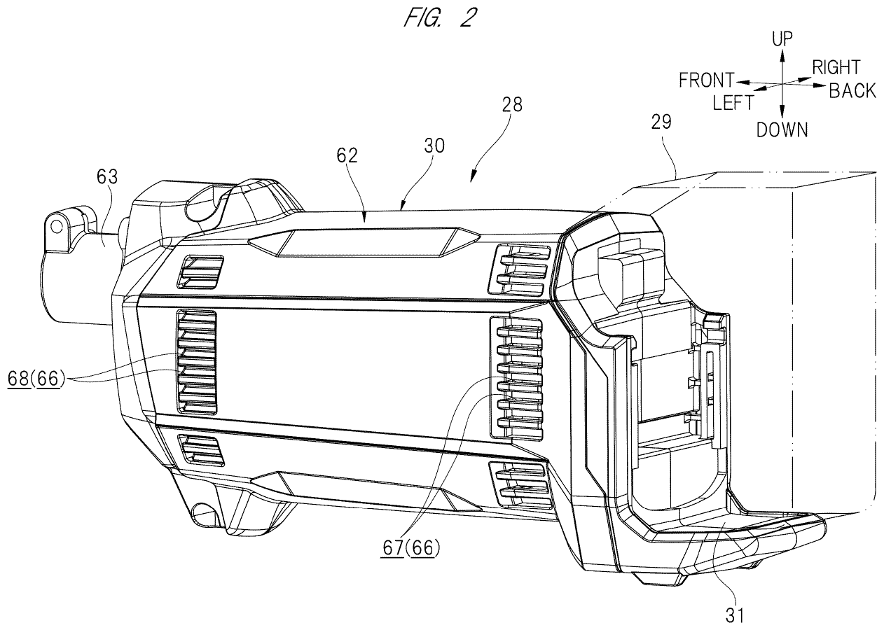

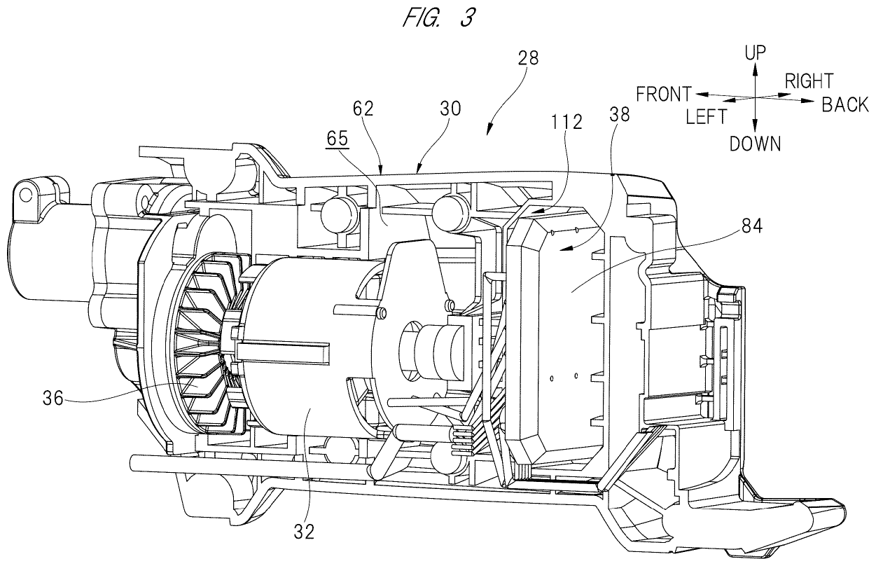

As illustrated in FIG. 2, the driving unit 28 includes a unit main body 30. A mounting portion 31 is provided at a back end of the unit main body 30. A battery pack 29 is detachably provided at the mounting portion 31. The battery pack 29 is detachable to the mounting portion 31 when being moved relative to the mounting portion 31 in the up/down direction. Specifically, the battery pack 29 is attached to the mounting portion 31 when being moved downward relative to the mounting portion 31, and is detached from the mounting portion 31 when being moved upward relative to the mounting portion 31. The battery pack 29 supplies a power to a motor 32 (FIG. 3) described later while being attached to the mounting portion 31. That is, the battery pack 29 functions as a power supply of the driving unit 28.

### <Unit Main Body>

As illustrated in FIG. 3, the unit main body 30 includes the motor 32, a fan 36, a control unit 38, a housing 62, and a front cover 112. The motor 32, the fan 36, and the control unit 38 are housed in a space 65 inside the housing 62. Note that the space 65 will be further described later.

### (Motor)

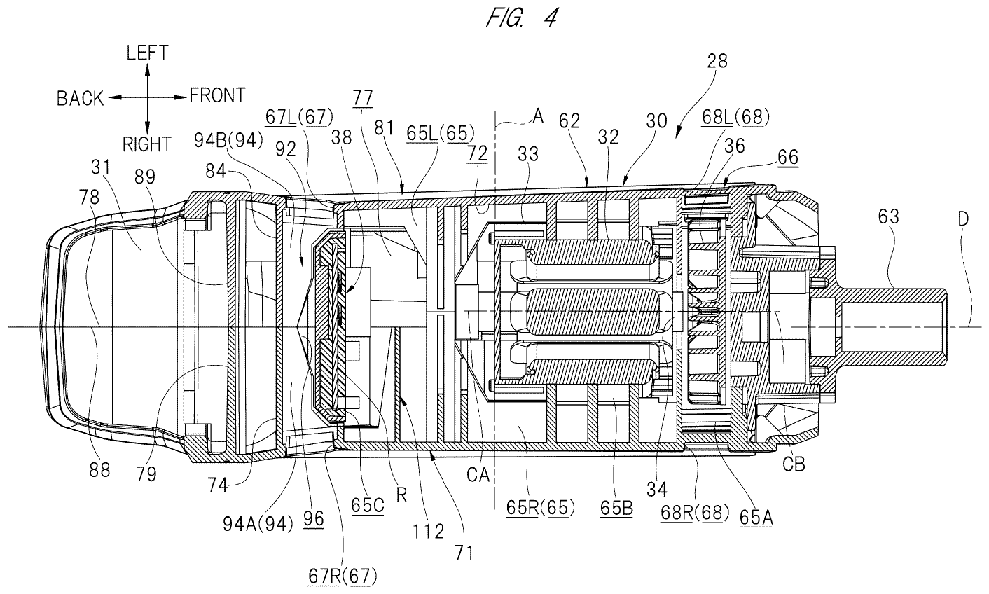

As illustrated in FIG. 4, the motor 32 is a brushless motor. A central axis of the motor 32 is illustrated as a first central axis CA with a dashed dotted line CA. The first central axis CA extends in the front-back direction. The motor 32 includes a main body case 33 and a shaft 34. The shaft 34 is rotated around the first central axis CA. Further, the shaft 34 extends forward from the main body case 33. A driving force of the motor 32 is transmitted to the drive shaft via a transmitting portion not illustrated. That is, the motor 32 rotates the drive shaft via the transmitting portion.

### (Fan)

The fan 36 is provided at a front end of the shaft 34. The fan 36 is a centrifugal fan. A central axis of the fan 36 is illustrated as CB with a dashed dotted line CB. The second central axis CB extends in the front-back direction. The second central axis CB and the first central axis CA are side by side in the front-back direction. That is, the first central axis CA and the second central axis CB are on the same straight line not illustrated. The fan 36 generates airflow in the space 65 when receiving the driving force of the motor 32. The airflow caused by the rotation of the fan 36 flows from a plurality of intake ports 67 (FIG. 4) described later toward a plurality of exhaust ports 68 (FIG. 4).

### (Control Unit)

As illustrated in FIG. 5, the control unit 38 includes a case 42 and a substrate portion 51. The control unit 38 is an exemplary controller. An outer shape of the control unit 38 when being viewed in the front-back direction is an octagonal shape (a rectangular shape, four corners of which are cut) Further, the control unit 38 has a plate shape, an outer shape of which is maximized when being viewed in the front-back direction. As described above, the front-back direction is an exemplary first direction, and corresponds to a thickness direction of the control unit 38. The right-left direction is an exemplary second direction. The up-down direction is an exemplary third direction. The right-left direction and the up-down direction cross each other when being viewed in the front-back direction.

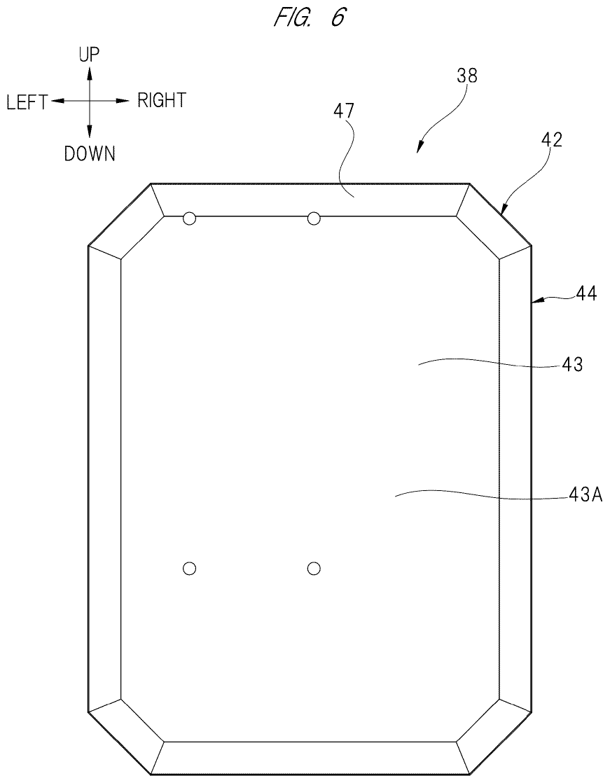

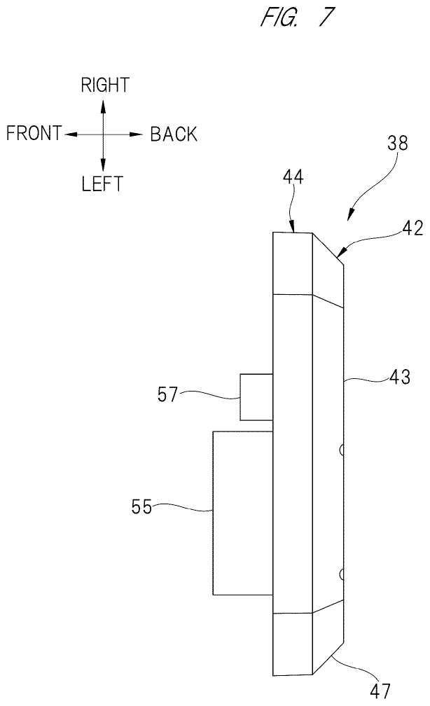

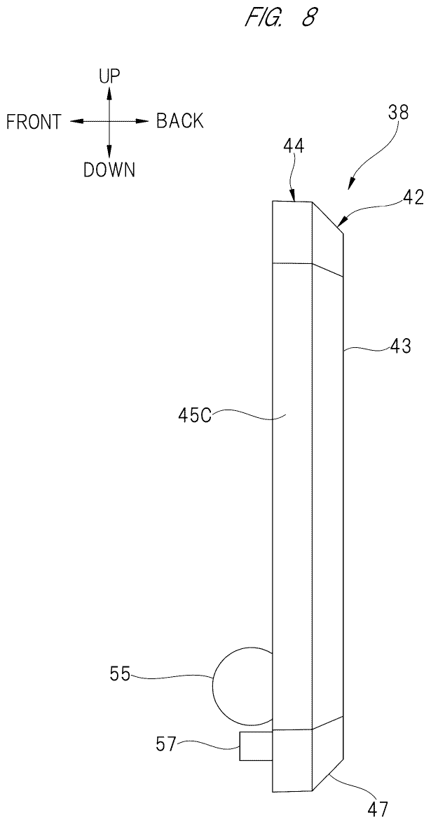

As illustrated in FIGS. 5, 6, 7, and 8, the case 42 is formed to have a dish shape to be open in the front direction. The case 42 is made of a metallic member. Note that the case 42 may be made of a resin member. A length of the case 42 in the up-down direction is longer than a length of the case 42 in the right-left direction. The case 42 houses the substrate portion 51 to expose a mounting surface 52A of the substrate portion 51 forward. Specifically, the case 42 includes a back wall 43 and a peripheral wall 44 that erects forward from an outer edge of the back wall 43. The back wall 43 has a flat back surface 43A (FIG. 6) spreading in the up-down direction and the right-left direction. A tapered surface 47 is formed in a region from a peripheral edge of the back surface 43A to a back end of the peripheral wall 44.

As illustrated in FIG. 5, the peripheral wall 44 is formed to have a frame shape with an octagonal outer shape when being viewed from front. Further, the peripheral wall 44 has an octagonal outer peripheral surface 45 when being viewed from front. The outer peripheral surface 45 has an upper surface 45A, a tilted surface 45B, a left side surface 45C, a tilted surface 45D, a lower surface 45E, a tilted surface 45F, a right side surface 45G, and a tilted surface 45H, all of which are flat. The upper surface 45A and the lower surface 45E extend in the right-left direction. The left side surface 45C and the right side surface 45G extend in the up-down direction.

The substrate portion 51 includes, for example, a control substrate 52, a field effect transistor (FET) 53, a shunt resistor 54, a capacitor 55, the microcomputer 56, and a connector 57. Illustration and explanation for other mounted components are omitted. The control substrate 52 has, for example, an outer shape in which each of the four corners of the rectangle is cut into L shape when being viewed in the front-back direction. The control substrate 52 is housed in the case 42 while its thickness direction is the front-back direction. Further, the control substrate 52 is fixed to the case 42 by a plurality of screws 59. A front surface of the control substrate 52 serves as the mounting surface 52A.

The FET 53, the shunt resistor 54, the capacitor 55, the microcomputer 56, and the connector 57 are mounted on the mounting surface 52A to be viewable from front. The microcomputer 56 is mounted on a region closer to the right side of the control substrate 52 than the center thereof in the right-left direction. A region, where the microcomputer 56 is mounted and a circuit pattern not illustrated for the operations of the microcomputer 56 is formed, is assumed as a mounting region S1. The microcomputer 56 is an exemplary control portion for controlling the driving of the motor 32 (FIG. 3). The microcomputer 56 adjusts operation voltage or frequency by use of an inverter circuit including the FET 53, thereby controlling the torque or the rotation speed of the motor 32.

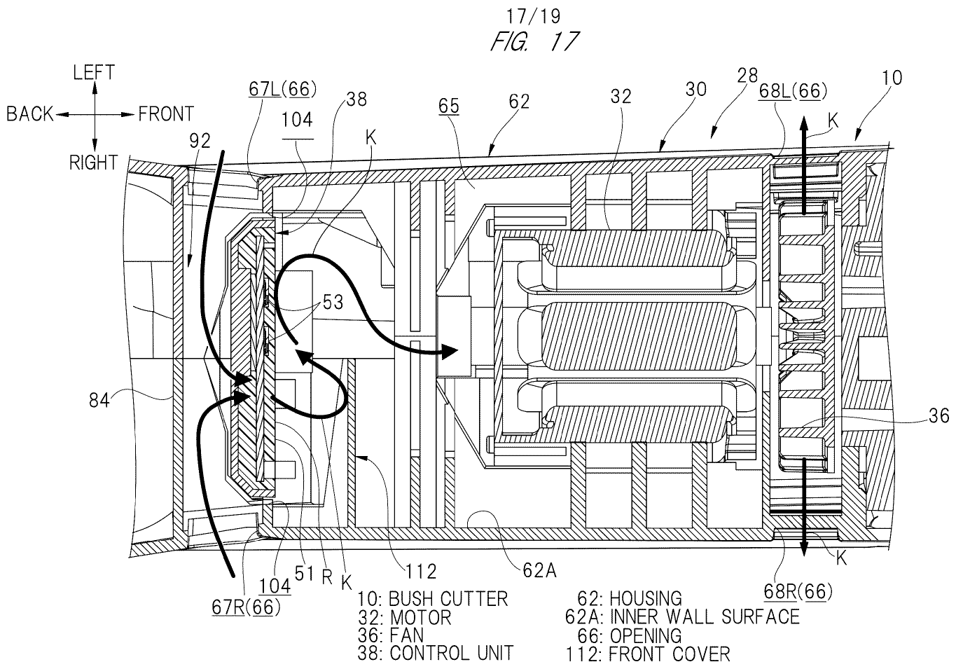

The FET 53, the shunt resistor 54, and the capacitor 55 are mounted on a region closer to the left side of the control substrate 52 than the center thereof in the right-left direction. A region, where the FET 53, the shunt resistor 54, and the capacitor 55 are mounted and a circuit pattern not illustrated is formed, is assumed as a mounting region S2. In the mounting region S2, the electric current to be flown in the motor 32 flows. The connector 57 is provided to, for example, straddle a lower end of the mounting region S1 and a lower end of the mounting region S2. The mounting regions S1 and S2 are covered with resin R (FIG. 4) from front. The case 42 is filled with the resin R, and the resin R is hardened. The exemplary resin R may be a curing resin such as urethane. Note that the resin R is not illustrated in other drawings than FIGS. 4 and 17.

Note that an amount of the electric current used for the driving of the motor 32 is larger than an amount of the electric current used for controlling the driving of the motor 32. That is, during the operation of the motor 32, the total amount of the electric current flowing in the mounting region S2 is larger than the total amount of the electric current flowing in the mounting region S1. Thus, an amount of heat generated in the mounting region S2 is larger than an amount of heat generated in the mounting region S1. Here, if the amount of the heat generated in the mounting region S2 exceeds an allowable amount, the operations of elements including the FET 53 possibly become unstable. In other words, if the amount of the heat generated in the mounting region S2 is large, the operation of the motor 32 possibly becomes unstable. Thus, the operation of the motor 32 is easier to be stabilized when the capability to cool the mounting region S2 is higher than the capability to cool the mounting region S1.

In the bush cutter 10 (FIG. 1), the microcomputer 56 is used as an exemplary control portion and as an exemplary first element. Further, the FET 53 is used as an exemplary second element. That is, the control unit 38 includes the microcomputer 56, and the FET 53 which generates more heat during the operation than the microcomputer 56. Note that at least either one of the shunt resistor 54 and the capacitor 55 may be used as the exemplary second element.

### (Housing)

As illustrated in FIG. 2, the housing 62 is formed to have a box shape extending in the front-back direction when being viewed in the right-left direction. A power transmitting portion 63 which houses the drive shaft not illustrated is provided at a front end of the housing 62. The mounting portion 31 is provided with a connector not illustrated. When the battery pack 29 is mounted on the mounting portion 31, power is supplied from the battery pack 29 into the housing 62.

As illustrated in FIG. 4, the housing 62 houses the motor 32, the control unit 38, and the fan 36 therein. The housing 62 further includes an opening 66. An imaginary line passing through almost the center of the housing 62 in the front-back direction and extending in the right-left direction when being viewed in the up-down direction is assumed here as a reference line A. Further, the housing 62 is divided into right and left as described later. An imaginary surface passing through the center of the housing 62 in the right-left direction and extending in the up-down direction is assumed as a division surface D. The division surface D is illustrated in a dashed dotted line D.

The opening 66 include a plurality of intake ports 67 and a plurality of exhaust ports 68. The plurality of intake ports 67 are positioned closer to the back side than the reference line A and to the front side than the mounting portion 31. Further, the plurality of intake ports 67 are arranged on the right and left sides of the division surface D to be distant from one another in the up-down direction. Note that the plurality of intake ports 67 are positioned closer to the back side than the control unit 38. The back side in the front-back direction is an exemplary one side in the first direction.

The plurality of exhaust ports 68 are positioned closer to the front side than the reference line A and to the back side than the power transmitting portion 63. Further, the plurality of exhaust ports 68 are arranged on the right and left sides of the division surface D to be distant from one another in the up-down direction. Further, the plurality of exhaust ports 68 are positioned closer to the front side than the control unit 38. In other words, the control unit 38 is arranged between the fan 36 and the plurality of exhaust ports 68 that are parts of the opening 66 in the front-back direction. Note that the front side in the front-back direction is an exemplary other side in the first direction.

Each of the intake ports 67 and the exhaust ports 68 is formed to have, for example, a rectangular shape extending in the front-back direction, and communicates between the inside and the outside of the housing 62. That is, air as exemplary gas can flow through the intake ports 67 and the exhaust ports 68. The air flowing in the housing 62 through the intake ports 67 by the rotation of the fan 36 flows forward in the housing 62, and flows outside through the exhaust ports 68.

The housing 62 is divided into the right and left sides of the division surface D. That is, the housing 62 includes a right housing 71 and a left housing 81. The right housing 71 is an exemplary first housing. The left housing 81 is an exemplary second housing. Note that the right side is an exemplary one side in the second direction. The left side is an exemplary other side in the second direction.

The intake port 67 provided in the right housing 71 is assumed as an intake port 67R. Further, the exhaust port 68 provided in the right housing 71 is assumed as an exhaust port 68R. The intake port 67 provided in the left housing 81 is assumed as an intake port 67L. Further, the exhaust port 68 provided in the left housing 81 is assumed as an exhaust port 68L. As described above, the plurality of intake ports 67R, 67L and the plurality of exhaust ports 68R, 68L are provided in the housing 62.

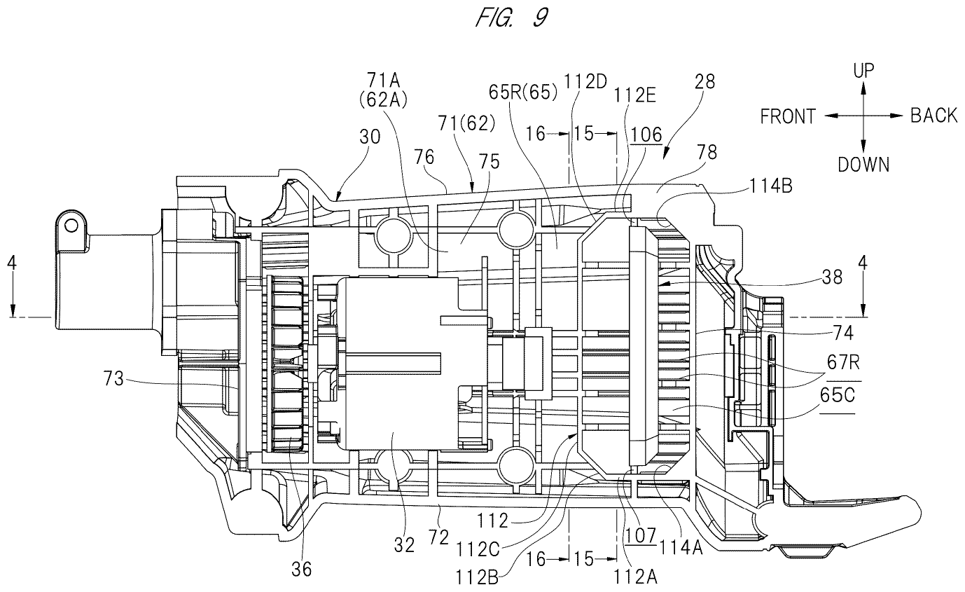

As illustrated in FIG. 9, the right housing 71 has a bottom wall 72, a front wall 73, a vertical wall 74, a right wall 75, and an upper wall 76. The bottom wall 72 is formed to have a plate shape with a predetermined thickness in the up-down direction. The front wall 73 erects upward from the front end of the bottom wall 72. The vertical wall 74 erects upward from the back end of the bottom wall 72. The right wall 75 erects upward from the right end of the bottom wall 72. The upper wall 76 extends in the right-left direction and the front-back direction from the upper ends of the front wall 73, the vertical wall 74, and the right wall 75. A region surrounded by the bottom wall 72, the front wall 73, the vertical wall 74, the right wall 75, and the upper wall 76 is assumed as a right space 65R. Note that the right housing 71 has a bonding surface 78 as a left-end surface of the right housing 71. And, the inner surface of the right housing 71 is assumed as an inner wall 71A. The inner wall 71A is an exemplary inner wall of the first housing.

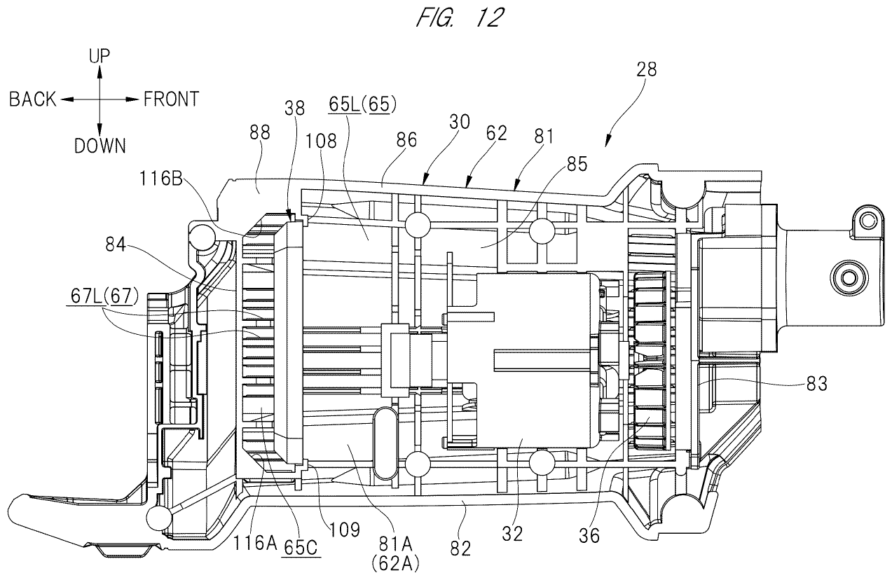

As illustrated in FIG. 12, the left housing 81 has a bottom wall 82, a front wall 83, a vertical wall 84, a left wall 85, and an upper wall 86. The bottom wall 82 is formed to have a plate shape with a predetermined thickness in the up-down direction. The front wall 83 erects upward from the front end of the bottom wall 82. The vertical wall 84 erects upward from the back end of the bottom wall 82. The left wall 85 erects upward from the left end of the bottom wall 82. The upper wall 86 extends in the right-left direction and the front-back direction from the upper ends of the front wall 83, the vertical wall 84, and the left wall 85. A region surrounded by the bottom wall 82, the front wall 83, the vertical wall 84, the left wall 85, and the upper wall 86 is assumed as a left space 65L. Note that the left housing 81 has a bonding surface 88 as a right-end surface of the left housing 81. And, the inner surface of the left housing 81 is assumed as an inner wall 81A. The inner wall 81A is an exemplary inner wall of the second housing. A combination of the inner wall surface 71A (FIG. 9) and the inner wall surface 81A is an inner wall surface 62A. The inner wall surface 62A is an exemplary inner wall of the housing 62.

As illustrated in FIG. 4, when screws not illustrated are fastened while the bonding surface 78 and the bonding surface 88 face each other in the right-left direction, the housing 62 and a space 65 inside the housing 62 are created. The space 65 includes a right space 65R and a left space 65L. Note that the bonding surfaces 78, 88 are included in the division surface D. A back wall 79 is provided closer to the back side than the vertical wall 74. A back wall 89 is provided closer to the back side than the vertical wall 84.

The space 65 includes a fan housing section 65A for housing the fan 36, a motor housing section 65B for housing the motor 32, and a controller housing section 65C for housing the control unit 38. The fan housing section 65A is positioned closer to the back side than the front wall 73 (FIG. 9) and the front wall 83 (FIG. 12). The motor housing section 65B is positioned closer to the back side than the fan housing section 65A. The controller housing section 65C is positioned closer to the back side than the motor housing section 65B. In the left housing 81, note that no wall is provided between the motor housing section 65B and the controller housing section 65C. In other words, in the left housing 81, a circulating portion 77 through which the gas can circulate is formed between the motor housing section 65B and the controller housing section 65C. To the contrary, in the right housing 71, the front cover 112 described later is provided between the motor housing section 65B and the controller housing section 65C in the front-back direction.

A flow passage 92 is provided between the control unit 38 and the vertical walls 74, 84 in the front-back direction. The flow passage 92 includes the vertical wall 74, the vertical wall 84, and a plurality of flow passage forming plates 94. The flow passage forming plate 94 has a predetermined thickness in the up-down direction. The plurality of flow passage forming plates 94 are arranged to be distant from one another in the up-down direction. The flow passage forming plate 94 is formed by combination of a right plate 94A on the right side of the division surface D and a left plate 94B on the left side of the division surface D in the right-left direction. The right plate 94A extends forward from the vertical wall 74 to reach an edge portion of the intake port 67R. The left plate 94B extends forward from the vertical wall 84 to reach an edge portion of the intake port 67L. As described above, the gas can circulate in the flow passage 92, and the gas taken in from the plurality of intake ports 67R, 67L flows toward the control unit 38.

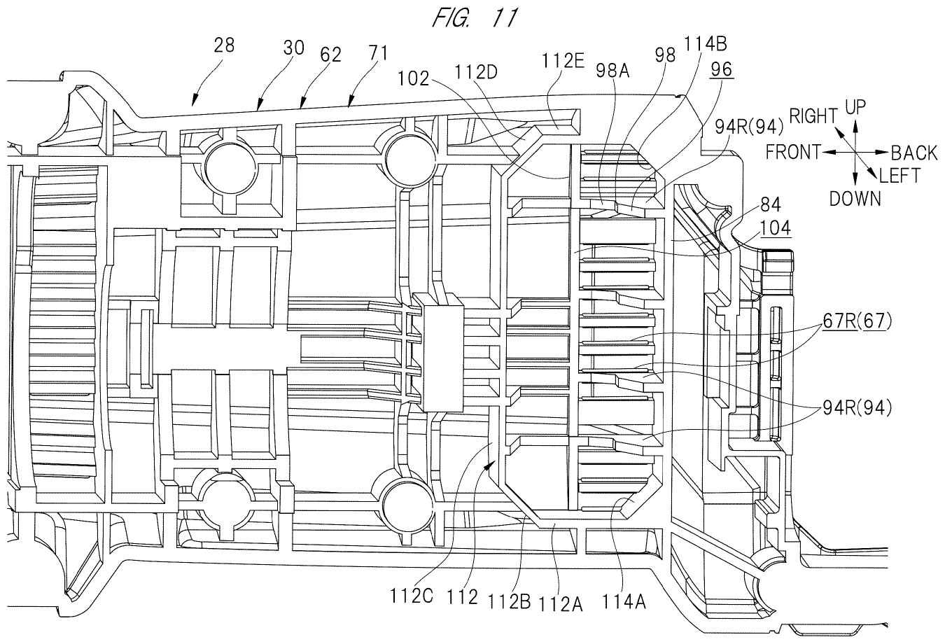

A cutout portion 96 and a unit supporting portion 98 (FIG. 11) are formed at a front end of the flow passage forming plate 94. The cutout portion 96 is cut out to be recessed from the center of the front end of the flow passage forming plate 94 in the right-left direction toward the back side. Further, the cutout portion 96 is cut out to have a V shape when being viewed in the up-down direction. In other words, the cutout portion 96 is cut out to be farther away from the control unit 38 as getting closer to the center in the right-left direction. The plurality of cutout portions 96 are arranged in the up-down direction, and the airflow can circulate therein in the up-down direction. In this way, the cutout portion 96 is an exemplary through-hole, and can penetrate the flow passage 92 in the up-down direction, thereby circulating the gas therethrough. In the present embodiment, note that the cutout portion 96 is included in the through-hole.

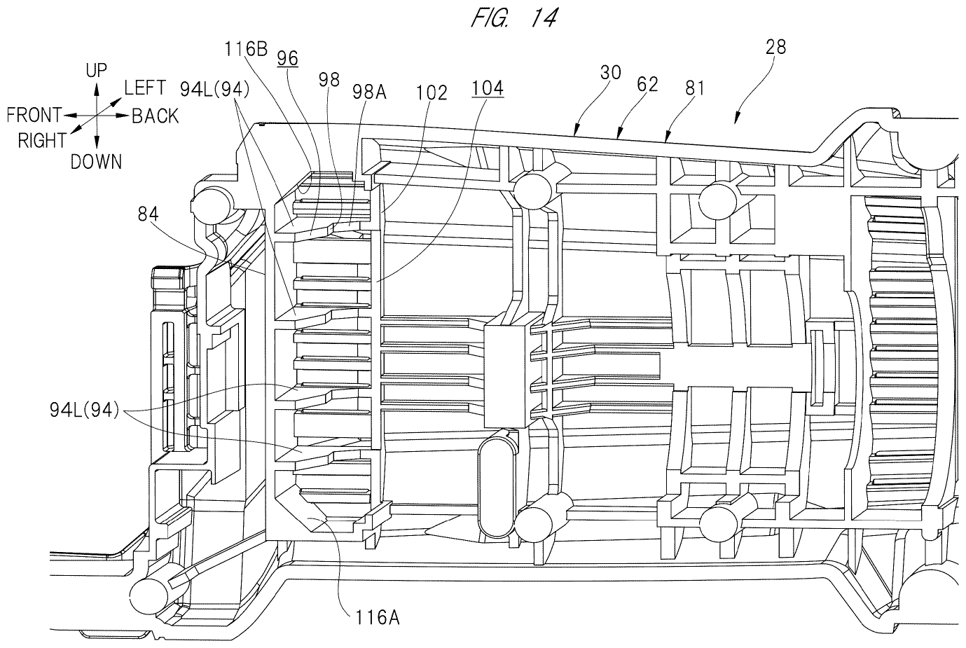

As illustrated in FIGS. 11 and 14, the unit supporting portion 98 is formed on the right and left sides of the cutout portion 96 at the front end of the flow passage forming plate 94. The unit supporting portion 98 has a supporting surface 98A facing the back surface 43A and the tapered surface 47 (FIG. 6). The supporting surface 98A is formed to match in the shape with the shapes of the back surface 43A and the tapered surface 47. When the supporting surface 98A is in contact with at least either one of the back surface 43A and the tapered surface 47, the unit supporting portion 98 supports the control unit 38 from the back side.

Partition walls 102 are provided at respective positions closer to the front side than the unit supporting portion 98, the positions being closer to the outside in the right-left direction than the control unit 38 (FIG. 4). The partition walls 102 protrude from the inner wall 62A toward the center in the right-left direction, and are formed to have a plate shape in which the front-back direction is a thickness direction. The partition walls 102 extend in the up-down direction.

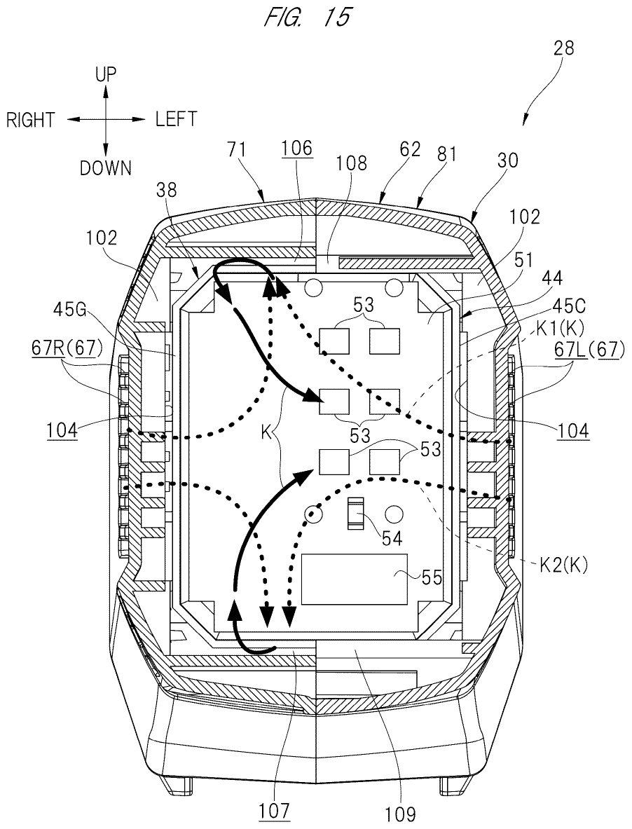

As illustrated in FIG. 15, a height of the partition wall 102 in the up-down direction is nearly the same as a height of the control unit 38 in the up-down direction. An upper end and a lower end of the partition wall 102 can be in contact with a left side surface 45C and a right side surface 45G of the control unit 38. In this way, the control unit 38 can be supported by the unit supporting portions 98 (FIG. 11) and the partition walls 102. In other words, the housing 62 can support both ends of the control unit 38 in the right-left direction.

A site of the partition wall 102, the site being adjacent to the control unit 38 in the right-left direction and being not the upper end and the lower end of the partition wall 102, is recessed to be away from the control unit 38. That is, a slit-shaped gap 104 is formed between a part of the partition wall 102 and the control unit 38. The gap 104 is formed to have a rectangular shape extending in the up-down direction when being viewed in the front-back direction. Further, the gap 104 has a size allowing the gas to circulate therein in the front-back direction. Further, the gaps 104 are positioned closer to the both outsides in the right-left direction than the control unit 38. Note that an amount of the gas flowing in the gaps 104 is smaller than an amount of the gas flowing in air passages 106, 107 described later. That is, most of the gas flows through the air passages 106, 107, and the rest of the gas flows through the gaps 104.

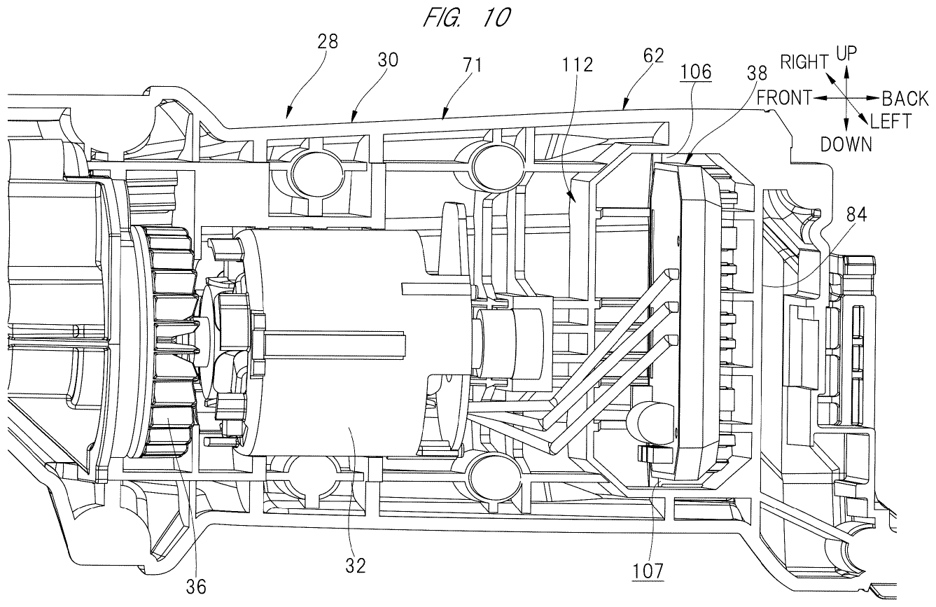

As illustrated in FIGS. 10 and 15, the right housing 71 is provided with the air passages 106 and 107. When the control unit 38 is attached to the housing 62, the air passages 106 and 107 are positioned closer to both outsides in the up-down direction than the control unit 38. The air passage 106 is positioned to be upper than a section corresponding to the mounting region S1 (FIG. 5) in the control unit 38, and enables the gas to circulate therein in the front-back direction. The air passage 107 is positioned to be lower than the section corresponding to the mounting region S1 (FIG. 5) in the control unit 38, and enables the gas to circulate therein in the front-back direction. The air passages 106 and 107 are not provided in the left housing 81.

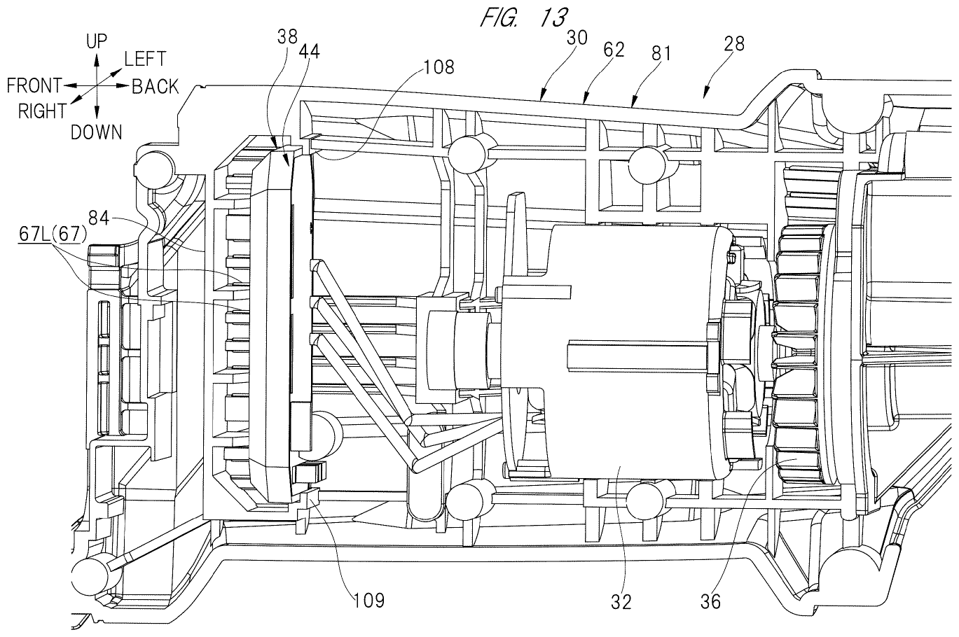

As illustrated in FIGS. 13 and 15, the left housing 81 is provided with limitation walls 108 and 109. When the control unit 38 is attached to the housing 62, the limitation walls 108 and 109 are positioned closer to both outsides in the up-down direction than the control unit 38. Each of the limitation walls 108 and 109 has a plate-shaped site expanding in the right-left direction and the up-down direction. Further, each of the limitation walls 108 and 109 is bent to have a cranked shape when being viewed in the right-left direction.

The limitation wall 108 is positioned closer to the upper side than a section corresponding to the mounting region S2 (FIG. 5) in the control unit 38, and limits the gas circulation in the front-back direction. Further, a lower end of the limitation wall 108 is in contact with an upper end of the peripheral wall 44 from front. The limitation wall 109 is positioned closer to the lower side than the section corresponding to the mounting region S2 in the control unit 38, and limits the gas circulation in the front-back direction. Further, an upper end of the limitation wall 109 is in contact with a lower end of the peripheral wall 44 from front. Note that the limitation walls 108 and 109 are not provided at the right housing 71 (FIG. 9).

The limitation wall 108 is adjacent to the air passage 106 in the right-left direction, and is positioned on the left side of the air passage 106. The limitation wall 109 is adjacent to the air passage 107 in the right-left direction, and is positioned on the left side of the air passage 107. In this way, inside the housing 62, the limitation walls 108 and 109 for limiting the airflow are provided on the left sides of the air passages 106 and 107 in the right-left direction, respectively, when being viewed in the front-back direction. Note that each of a lower end of the limitation wall 108 and an upper end of the limitation wall 109 functions as a preventing portion for preventing the control unit 38 from tilting forward.

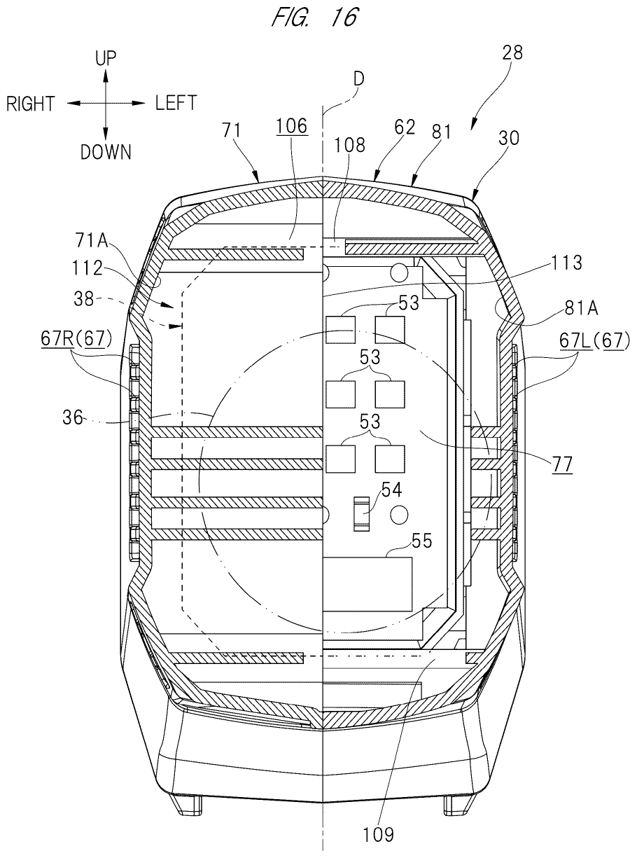

As illustrated in FIG. 16, the front cover 112 is erected rightward in the right-left direction from the inner wall 71A of the right housing 71 (toward the left housing 81). The front cover 112 is an exemplary wall. The front cover 112 is erected to overlap the right side of the division surface D of the control unit 38 when being viewed from front to back in the front-back direction. In other words, the front cover 112 is positioned on the right side as the other side in the right-left direction when being viewed in the front-back direction. A left end surface 113 is formed on the left end of the front cover 112. The left end surface 113 is an exemplary tip of the wall. The left end surface 113 is formed to have a planar shape on the division surface D. As described above, the front cover 112 is provided only in the right housing 71, and is not provided in the left housing 81 (FIG. 12).

As illustrated in FIG. 9, the front cover 112 has a bottom wall 112A, a tilted wall 112B, a front wall 112C, a tilted wall 112D, and an upper wall 112E. The bottom wall 112A is positioned closer to the down side than the control unit 38, and extends to be closer to the front side than the control unit 38. The tilted wall 112B extend diagonally upward from a front end of the bottom wall 112A. The front wall 112C extends upward in the up-down direction from an upper end of the tilted wall 112B. The tilted wall 112D extends diagonally backward from an upper end of the front wall 112C. The upper wall 112E extends backward from an upper end of the tilted wall 112D. The upper wall 112E is positioned closer to the upper side than the control unit 38.

As illustrated in FIG. 16, the front cover 112 overlaps the fan 36 when being viewed from front to back in the front-back direction. Specifically, when the fan 36 is projected on the front cover 112 along the front-back direction, a part of the fan 36, the portion being closer to the right side than the division surface D, overlaps the front cover 112. When being viewed in the front-back direction, a part of the fan 36, the part being closer to the left side than the division surface D, partially does not overlap the front cover 112 but overlaps the control unit 38.

When being viewed from front to back in the front-back direction, the FET 53, the shunt resistor 54, and a part of the capacitor 55 are positioned between the left end surface 113 and the inner wall 81A. In other words, the FET 53, the shunt resistor 54, and the part of the capacitor 55 are not covered with the front cover 112 when being viewed in the front-back direction. Thus, the airflow can cool the FET 53, the shunt resistor 54, and the capacitor 55, and then, can flow forward through the circulating portion 77 without being limited by the front cover 112.

As illustrated in FIG. 9, the controller housing section 65C is provided with tilted surfaces 114A and 114B. The tilted surface 114A extends diagonally downward from the lower end of the vertical wall 74 toward the bottom wall 112A. The tilted surface 114B extends diagonally upward from the upper end of the vertical wall 74 toward the upper wall 112E. Thus, the gas flowing from the plurality of intake ports 67R into the controller housing section 65C is guided by the tilted surfaces 114A and 114B, thereby flowing into the air passages 106 and 107. Note that the controller housing section 65C is formed to have an octagonal shape when being viewed from left to right in the right-left direction.

As illustrated in FIG. 12, the controller housing section 65C is provided with tilted surfaces 116A and 116B. The tilted surface 116A extends diagonally downward from the lower end of the vertical wall 84 toward a position lower than the control unit 38. The tilted surface 116B extends diagonally upward from the upper end of the vertical wall 84 toward a position upper than the control unit 38. Note that the left housing 81 is provided with the limitation walls 108 and 109. Thus, the forward flow of the gas flowing from the plurality of intake ports 67L into the controller housing section 65C is limited by the tilted surfaces 116A and 116B.

### Operations and Effects of Present Embodiment

As illustrated in FIG. 17, when the motor 32 in the bush cutter 10 starts operating, the fan 36 is rotated, thereby generating the airflow in the space 65 of the housing 62. That is, the gas (such as air) flowing into the space 65 through the intake ports 67 flows forward in the space 65, and then, is exhausted outside the housing 62 through the exhaust ports 68. Specifically, the gas flowing through the plurality of intake ports 67R and the gas flowing through the plurality of intake ports 67L flow in a region closer to the back side than the control unit 38, thereby cooling the back side of the control unit 38. In the following description, the airflow is illustrated with an arrow K, and is denoted as airflow K.

As illustrated in FIG. 15, airflow flowing in a space being closer to the back side than the control unit 38 and facing the upper portion of the control unit 38 is assumed as airflow K1. Further, airflow flowing in a space being closer to the back side than the control unit 38 and facing the lower portion of the control unit 38 is assumed as airflow K2. The forward flow of the airflow K1 is limited by the control unit 38 and the limitation wall 108, and thus, this airflow flows toward the opened air passage 106. The airflow Kl then flows beyond the front side of the control unit 38 when passing through the air passage 106, and then, starts flowing downward and forward. The forward flow of the airflow K2 is limited by the control unit 38 and the limitation wall 109, and thus, this airflow flows toward the opened air passage 107. The airflow K2 then flows beyond the front side of the control unit 38 when passing through the air passage 107, and then, starts flowing upward and forward. A part of the airflow K1 and a part of the airflow K2 are combined with each other to become airflow K.

As illustrated in FIG. 17, the airflow K flowing beyond the control unit 38 tends to flow further forward. Here, the airflow K collides against the front cover 112, thereby limiting the forward flow, and is guided by the front cover 112, thereby causing the flow toward the left side of the control unit 38. In other words, the flow direction of the airflow K is turned back at the front cover 112, thereby causing the flow toward the front of the left side of the control unit 38.

As illustrated in FIGS. 15 and 17, the airflow K flows toward the front of the left side of the control unit 38, and collides against the substrate portion 51, thereby turning back the flowing direction toward the front side. In this case, the airflow K flows toward the FET 53, the shunt resistor 54, and the capacitor 55. Thereby, the FET 53, the shunt resistor 54, and the capacitor 55 are cooled. The airflow K then flows forward, and is exhausted outside the housing 62 through the plurality of exhaust ports 68.

Note that the gaps 104 are provided closer to both outsides than the control unit 38 in the right-left direction. Thus, a part of the airflow K flowing in the flow passage 92 flows forward through the gaps 104, thereby cooling the left side surface 45C and the right side surface 45G, and thus, both ends of the case 42 in the right-left direction can be also cooled.

Specific description will be made below with reference to FIGS. 1 to 17. The description for individual drawing numbers will not be omitted. In the bush cutter 10, the fan 36 is rotated, thereby causing the airflow K toward the control unit 38. The back side of the control unit 38 is cooled by the airflow K. The airflow K cooling the back side of the control unit 38 flows along the control unit 38, thereby causing the flow beyond the front side of the control unit 38 from the back side in the front-back direction. Here, the front cover 112 is arranged to overlap the control unit 38 when being viewed in the front-back direction. Thus, the airflow K having flown beyond the front side of the control unit 38 collides against the front cover 112. The airflow K having collided against the front cover 112 is changed in the direction to be turned back, thereby causing the flow toward the control unit 38. In particular, the airflow K is guided by the front cover 112, thereby causing the flow toward the mounting region S2. The airflow K then cools the FET 53, the shunt resistor 54, and the capacitor 55. As described above, since not only the back side of the control unit 38 but also the front side thereof are cooled, increases in temperatures of particularly the FET 53, the shunt resistor 54, and the capacitor 55 in addition to the microcomputer 56 can be suppressed. Therefore, even if the load on the bush cutter 10 during the operation increases, the operations of the circuit including the microcomputer 56, the FET 53, the shunt resistor 54, and the capacitor 55 are stabilized, and thus, the driving of the motor 32 can be continued. That is, the operation stop of the bush cutter 10 due to the increase in the temperature of the control unit 38 is suppressed, thereby enhancing the workability of the bush cutter 10.

In the bush cutter 10, the air passages 106 and 107 allowing the gas to flow toward the control unit 38 and the upper ends and the lower ends of the partition walls 102 supporting the control unit 38 are arranged at both sides in the right-left direction and the up-down direction. This enables the passage area of the air passages 106 and 107 to be larger and enables the tilt of the control unit 38 to be easier to be suppressed than a structure in which the airflow portion and the portion for supporting the control unit 38 are collectively arranged in the same region.

In the bush cutter 10, the limitation walls 108 and 109 limit the airflow K of the left side of the air passages 106 and 107. Thereby, the airflow K flows toward the right side of the air passages 106 and 107. The airflow K having flown beyond the control unit 38 collides against the front cover 112, thereby guiding the flow toward the left side of the control unit 38 (toward the mounting region S2). That is, this enables the airflow K having flown through the air passages 106 and 107 to be easier to flow toward the front cover 112 and easier to be turned back than a structure in which the air passages 106 and 107 are opened entirely in the right-left direction, and thus, the front side of the control unit 38 can be easily cooled.

In the bush cutter 10, the airflow K caused by rotation of the fan 36 flows from the plurality of intake ports 67, and flows beyond the control unit 38 to the plurality of exhaust ports 68. In this case, the plurality of intake ports 67 are arranged at both sides of the housing 62 in the right-left direction, and thus, this structure is easier to take in the gas than a structure in which the intake ports 67 are arranged only at one side in the right-left direction. Further, the flow passage 92 guides the airflow K toward the control unit 38, and thus, more airflow K can flow toward the back surface 43A of the control unit 38.

In the bush cutter 10, a part of the airflow K guided by the flow passage 92 flows through the cutout portions 96 in the up-down direction. The airflow K having flown in the up-down direction reaches the upper and lower ends of the control unit 38, and then, flows beyond the control unit 38 in the front-back direction. Thereby, staying of a part of the airflow K in each flow passage 92 is difficult to occur, and thus, the airflow K easily flows beyond the control unit 38 in the front-back f direction.

In the bush cutter 10, a space for arranging the fan 36 and the front cover 112 in the right-left direction or the up-down direction can be made smaller than a structure in which the fan 36 and the front cover 112 do not overlap each other when being viewed in the front-back direction, and thus, the bush cutter 10 can be downsized.

In the bush cutter 10, a space for arranging the motor 32 and the fan 36 in the right-left direction or the up-down direction can be made smaller than a structure in which the first central axis CA and the second central axis CB are not side by side in the front-back direction, and thus, the bush cutter 10 can be downsized.

In the bush cutter 10, the front cover 112 is provided only at the right housing 71. Thus, the front cover 112 and the right housing 71 can be integrally formed. Thereby, the number Of steps for manufacturing the bush cutter 10 can be made smaller than a structure in which the front cover 112 and the right housing 71 are separately formed.

In the bush cutter 10, the airflow K is guided by the front cover 112, and thus, flows toward the left end surface 113 of the front cover 112 and toward the mounting region S2 of the control unit 38. In this case, the FET 53 is positioned between the left end surface 113 and the inner wall 81A when being viewed from front to back in the front-back direction. In other words, the FET 53 is positioned on the passage of the airflow K. Thereby, the FET 53 which generates more heat can be easily cooled by the airflow K.

### Modification Example of Present Embodiment

It is needless to say that the present invention is not limited to the foregoing embodiments, and various modifications can be made within the scope of the present invention. In the above explanation, the motor 32 rotates the rotary blade 24 as a tool. However, the motor 32 is not limited for driving the tool. The fan 36 is not limited to the centrifugal fan, and may be an axial-flow fan. If the fan 36 is the axial-flow fan, it is only required that the fan 36 is arranged closer to the back side than the control unit 38 to blow wind toward the back surface 43A of the control unit 38. In the bush cutter 10, the components may be arranged left and right oppositely with respect to the division surface D.

The components may be arranged while the up-down direction is the exemplary second direction and the right-left direction is the exemplary third direction. The shape of the case 42 is not limited to the assemble body of planar surfaces, and may partially have a curved surface. The structure of the housing 62 is not limited to the two divided structure, and may be a three or more divided structure. The structure of the front cover 112 is not limited to the assemble body of planar surfaces, and may partially have a curved surface. The flow passage forming plate 94 may be provided with a through-hole penetrating the flow passage forming plate 94 in the up-down direction, instead of the cutout portion 96. The number of the through-holes may be either one or more.

The front cover 112 may extend toward the left side beyond the division surface D. This structure may not be provided with the limitation walls 108 and 109. The housing 62 may not be provided with the flow passage 92. For example, the plurality of flow passage forming plates 94 may not be provided. If the number of the flow passage forming plate 94 is one, the cutout portion 96 may not be provided. The fan 36 and the front cover 112 may not overlap each other when being viewed in the front-back direction.

The first central axis CA and the second central axis CB may not be side by side in the front-back direction. The front cover 112 may be erected from the inner wall 71A toward the control unit 38 in a direction crossing the right-left direction when being viewed in the up-down direction. Further, the shape of the front cover 112 is not limited to a plate shape, and may be an entirely-or partially-curved shape. The FET 53, the shunt resistor 54, and the capacitor 55 may be partially arranged to overlap the front cover 112 when projected in the front-back direction.

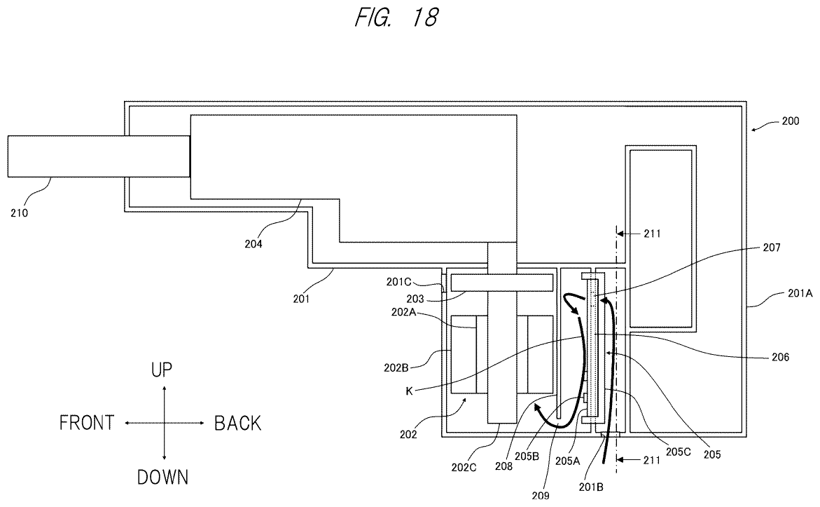

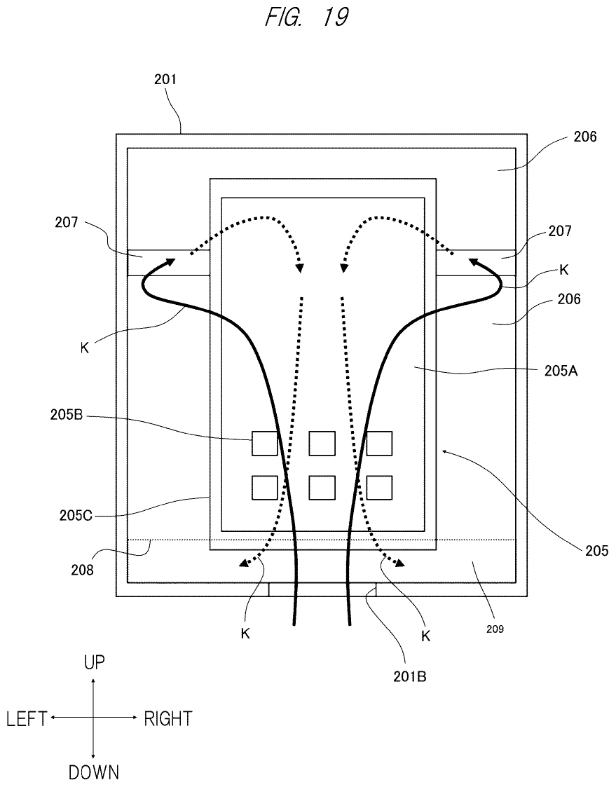

FIGS. 18 and 19 illustrate a hammer drill 200 according to a second embodiment of the present invention. In the hammer drill 200, the hammer drill 200 includes a motor 202 including a rotor 202A, stator 202B, and a drive shaft 202C therein, and a tip tool 210 is operated by a mechanism 204 operating when receiving a driving force of the motor 202 to drill or crush a workpiece such as concrete. The mechanism 204 can give, by using the driving force of the motor 202, a striking force for striking the tip tool in a longitudinal direction (the front-back direction) and a rotative force for rotating the tip tool around an axis extending in the longitudinal direction (the front-back direction) to the tip tool. The housing 201 is provided with a switching portion not illustrated for switching modes of the mechanism 204. When the mode of the mechanism 204 is switched to a hammer mode by the switching portion, only the striking force is given to the tip tool. When the mode of the mechanism 204 is switched to a hammer drill mode by that, the striking force and the rotative force are given to the tip tool. When the mode of the mechanism 204 is switched to a drill mode by that, only the rotative force is given to the tip tool.

A control unit 205 for controlling the driving of the motor 202 is housed in the housing 201. The control unit 205 includes a control substrate 205A, a FET 205B (exemplary switching element) mounted on the control substrate 205A, and a case 205C for housing the control substrate 205A therein. The case 205C is made of metal, and has a box shape covering back, upper, lower, right, and left surfaces of the control substrate 205A and having a front surface which is opened. The control unit 205 has a plate shape with the outer diameter size maximized when being viewed from front (in the first direction).

The housing 201 is provided with an intake port 201B. A fan 203 is attached to the drive shaft 202C of the motor 202. The fan 203 is positioned closer to the front side than the control unit 205, the intake port 201B is positioned closer to the back side than the control unit 205, and thus, the control unit 205 is arranged between the intake port 201B and the fan 203 in the front-back direction. A space closer to the back side and a space closer to the front side than the control unit 205 are partitioned by a limitation wall 206 in the front-back direction, and the intake port 201B is connected to the space closer to the back side. A position of the limitation wall 206 is positioned to overlap the control unit 205 in the front-back direction. Further, the limitation wall 206 is provided with an air passage 207 adjacent to the control unit 205 in the right-left direction. It is only required that the air passage 207 is arranged on at least one of right and left sides of the control unit 205. However, according to the present embodiment, the air passage 207 is arranged on both right and left sides. A space facing the control unit 205 and a space provided with the motor 202 in a region closer to the front side than the limitation wall 206 are partitioned by a front cover 208 erected from the inner wall of the housing 201. The front cover 208 is arranged to overlap the control unit 205 when being viewed in the front-back direction as illustrated in FIG. 19, and its position in the front-back direction is arranged between the control unit 205 and the fan 203. The front cover 208 is provided with a circulating portion 209 which is arranged to be lower than the air passage 207 and which communicates the space facing the control unit 205 and the space provided with the motor 202.

The airflow K which is generated by the fan 203 at the time of the driving of the motor 202 and which flows around the control unit 205 will be explained. The airflow K having entered the housing 201 through the intake port 201B flows upward along the back surface of the case 205C from the center of the control unit 205 in the right-left direction to be away in the right-left direction. At this time, the airflow K cools the case 205C, and indirectly cools the control substrate 205A and the FET 205B. Then, the airflow K flows through the air passage 207 provided at the limitation wall 206, thereby causing the flow entering the space on the front side of the limitation wall 206 from the space on the back side of the limitation wall 206. At this time, the flow direction of the airflow K changes toward the center of the control unit 205 in the right-left direction. Then, the airflow K collides against the front cover 208, thereby changing the flow direction downward and backward. That is, the front cover 208 guides the airflow K downward to the circulating portion 209. At this time, the airflow K collides against particularly a periphery of the FET 205B of the control substrate 205A, and cools them. Further, the airflow K flows through the circulating portion 209 to a region closer to the front side than the front cover 208, flows upward to the fan 203 through a periphery of the motor 202, and then, flows outside the housing 201 through an exhaust port 201C.

Also in the hammer drill 200 according to the second embodiment, particularly the FET 205B of the control unit 205 is effectively cooled, thereby enhancing the workability of the working machine.

The working machine to which the present invention is applied is not limited to the bush cutter or the hammer drill, and the present invention is applicable to various working machines each provided with a motor, a controller, and a fan.

### EXPLANATION OF REFERENCE CHARACTERS

10: Bush cutter (exemplary working machine), 32: Motor, 36: Fan, 38: Control unit (exemplary controller), 53: FET (exemplary second element), 56: Microcomputer (exemplary control portion and exemplary first element), 62: Housing, 62A: Inner wall (exemplary inner wall of housing), 66: Opening, 67: Intake port, 68: Exhaust port, 71: Right housing (exemplary first housing), 71A: Inner wall (exemplary inner wall of first housing), 81: Left housing (exemplary second housing), 81A: Inner wall (exemplary inner wall of second housing), 92: Circulating portion, 96: Cutout portion (exemplary through-hole), 106: Air passage, 107: Air passage, 108: Limitation wall, 109: Limitation wall, 112: Front cover (exemplary wall), 113: Left end surface (exemplary tip), CA: First central axis, CB: Second central axis, 201: Housing, 201A: Handle, 201B: Intake port, 201C: Exhaust port, 202: Motor, 202A: Rotor, 202B: Stator, 202C: Drive shaft, 203: Fan, 204: Mechanism, 205: Control unit, 205A: Control substrate, 205B: FET, 205C: Case, 206: Limitation wall, 207: Air passage, 208: Front cover, 209: Circulating portion, 210: Tip tool

1. A working machine comprising:
a motor;
a controller provided with a control portion configured to control driving of the motor;
a fan configured to generate airflow when receiving a driving force of the motor; and
a housing configured to house the motor, the controller, and the fan and to include an opening,
wherein the controller has a plate shape with an outer shape size maximized when being viewed in a first direction, and is arranged between the opening and the fan in the first direction,
the working machine further includes:
an air passage to be a passage in which air flow flows from one side to the other side of the controller in the first direction;
a limitation wall arranged at one side of the air passage in a second direction orthogonal to the first direction, and configured to limit the air flow; and
a wall erected from an inner wall of the housing, provided at the other side in the second direction to overlap the controller when being viewed in the first direction.

2. A working machine comprising:
a motor;
a controller provided with a control portion configured to control driving of the motor;
a fan configured to generate airflow when receiving a driving force of the motor; and
a housing configured to house the motor, the controller, and the fan and to include an opening,
wherein the controller has a plate shape with an outer shape size maximized when being viewed in a first direction, and is arranged between the opening and the fan in the first direction,
in an assumption that directions crossing each other when being viewed in the first direction are a second direction and a third direction,
the opening is adjacent to the controller in the second direction when being viewed in the first direction,
the housing is configured to support both ends of the controller in the second direction,
an air passage is provided in the housing and positioned on an outside of the controller in the third direction, and
a limitation wall configured to limit airflow at one side of the air passage in the second direction is provided in the housing when being viewed in the first direction.

3. The working machine according to claim 1,
the opening is adjacent to the controller in the second direction when being viewed in the first direction,
the housing is configured to support both ends of the controller in the second direction,
an air passage is provided in the housing and positioned on an outside of the controller on both sides of the third direction,
a limitation wall configured to limit airflow at one side of the air passage in the second direction is provided in the housing when being viewed in the first direction, and
the wall is positioned at the other side of the air passage in the second direction when being viewed in the first direction.

4. The working machine according to claim 3,
wherein the opening includes:
a plurality of intake ports arranged at a position closer to one side in the first direction than the controller; and
a plurality of exhaust ports arranged at a position closer to the other side in the first direction than the controller, and
the housing is provided with the plurality of intake ports at both sides in the second direction and is provided with a flow passage through which gas flows from the plurality of intake ports toward the controller.

5. The working machine according to claim 4,
wherein the flow passage is provided with a through-hole penetrating the flow passage in the third direction and configured to flow gas.

6. The working machine according to claim 1,
wherein the fan and the wall overlap each other when being viewed in the first direction.

7. The working machine according to claim 6,
wherein a first central axis of the motor and a second central axis of the fan are side by side in the first direction.

8. The working machine according to claim 7,
wherein the housing includes a first housing and a second housing which are partitioned at one side and the other side in a second direction crossing the first direction, and
the wall is erected from an inner wall of the first housing toward the second housing.

9. The working machine according to claim 8,
wherein the controller includes:
a first element; and
a second element which generates more heat during operation than the first element, and
the second element is positioned between a tip of the wall and an inner wall of the second housing when being viewed in the first direction.

10. A working machine comprising:
a motor;
a controller provided with a control portion configured to control driving of the motor;
a fan configured to generate airflow when receiving a driving force of the motor; and
a housing configured to house the motor, the controller, and the fan and to include an intake port,
wherein the controller has a plate shape with an outer shape size maximized when being viewed in a first direction, and is arranged between the intake port and the fan in the first direction, and
the housing includes:
an air passage, a position of which in the first direction is arranged to overlap the controller;
a circulating portion, a position of which in the first direction is between the controller and the fan and is arranged not to overlap the air passage when being viewed in the first direction; and
a wall erected from an inner wall of the housing to guide airflow having passed through the air passage, toward the circulating portion.
